(19) United States
(12) Patent Application Publication
(10) Pub. No.: US 2013/0075316 A1
(43) Pub. Date: Mar. 28, 2013

(54) METHOD OF TREATING WATER POLLUTANT

(71) Applicants: Ku-Fan Chen, Nantou (TW); Yu-Chen Chang, Nantou (TW); Hung-Jen Huang, Nantou (TW); Ting-Yu Chen, Nantou (TW)

(72) Inventors: Ku-Fan Chen, Nantou (TW); Yu-Chen Chang, Nantou (TW); Hung-Jen Huang, Nantou (TW); Ting-Yu Chen, Nantou (TW)

(73) Assignee: NATIONAL CHI NAN UNIVERSITY, Nantou (TW)

(21) Appl. No.: 13/244,622

(22) Filed: Sep. 25, 2011

(51) Int. Cl. C02F 1/28; C02F 1/72

(52) U.S. Cl. 210/170.07; 210/198.1

(57) ABSTRACT

A water pollutant processing method to adsorb, oxidize and activate water pollutants includes using an adsorbent with low oxidation number (zeolite), an activator (from industrial wastes, such as BF slags and BOF slags) and a persulfate to process polluted water and underground water. The method includes an integrated processing system including the persulfate, adsorbent with low oxidation number and iron-containing activator. The integrated processing system not only possesses an adsorbing capability, but also an oxidizing capability using transition metal such as iron on the surface of the activator. The system can not only accelerate removal of water pollutants, but also delay movement of the pollutants to further reduce threat of pollutant spreading to downstream. BF and BOF slags are industrial wastes and the present invention also provides a channel for reusing the wastes.

### FIELD OF THE INVENTION

The present invention is related to a method of treating water pollutant with the functions of adsorption, oxidation and activation, and more particularly to a method of treating water pollutant using persulfate to stably combine with adsorbent (with low oxidation number) and iron-containing activator.

### BACKGROUND OF THE INVENTION

Groundwater contaminated by gasoline and other petroleum hydrocarbons has become a more common and serious problem. The source of contamination mainly comes from underground storage tank leakage, pipeline rupture and ground oil leakage, etc. Since the pipelines of gas stations and large oil storage tanks are located underground and with aging facilities, earthquakes, poor construction or other human factors, the possibility of oil leakage has increased. In the United States, there are more than two million oil storage tanks and it is estimated that 35% of the oil storage tanks may be leaking (Bedient et al., 1999). In Taiwan, oil pollution cases are also gradually increasing, while the soil and groundwater pollution, is an important topic for countries all over the world.

Conventional treatment of contaminated groundwater technologies, such as extraction processing method (pump and treat, R & T) are widely used in various contamination processing sites, but traditional methods are often lengthy, and long-term remediation may be required that increases the costs. Current remediation of contaminated sites, considering costs and other factors, use (in-site) remediation methods (US EPA, 2004).

In situ chemical oxidation (ISCO) is a method that injects oxidant into the contaminated area to destroy the target pollutants. Ideally, pollutants will be completely oxidized to carbon dioxide, water and other harmless substances (ITRC, 2005). Common oxidants include hydrogen peroxide (H₂O₂) [Fenton's reagent], permanganate, persulfate and ozone. Using sulfate as an oxidant is a relatively newly developed chemical processes (ITRC, 2005). Persulfate is a strong oxidant, and if activated by heat or metal (such as ferrous iron), it can produce sulfate radicals (SO₄⁻.) to rapidly degrade pollutants (Shiying et al., 2008; Chen et al., 2009). Conventional methods of in-site chemical oxidation, such as FIGS. 7 and 8, are related to a “method of continuously releasing oxidants in polluted water to degrade pollutants and components to release oxidants.” The method includes: providing an oxidant releasing composition (300) that includes a persulfate (310), a curing agent (320) (cement) and a plurality of fine particles (330) and water mixed with an appropriate ratio; and placing the oxidant releasing composition (300) with a plurality of micro-pores (340) into medium (32) containing water pollutants; wherein the water in the medium flows into the oxidant releasing composition (300) through the micro-pores (340), and the persulfate (310) is water-dissolvable and slowly releases into the medium containing water pollutants.

However, the method mentioned above still has following problems: (a) only the curing agent (320) (cement) and persulfate (310) to form the oxidant releasing composition (300) to remove contaminants from water, but when the persulfate (310) is not activated, it is not efficient to remove water pollutants; (b) additional costs may be necessary to accelerate the removal of pollutants, like using heat or adding additional transition metal catalysts such as iron (II) persulfate (310), which will not only increased costs, but also reduce permeability of a water-containing layer because after ferrous iron (oxidation number 2) becomes ferrous ion (oxidation number 3) through oxidation, the precipitation will increase to clog the water-containing layer.

Therefore, there is a need for an improved and new integrated processing system serving the functions of adsorption, activation and oxidation to speed up degradation of the pollutants and delay the movement of the pollutants and further reduce the threat to the downstream.

### SUMMARY OF THE INVENTION

The present invention provides a method of handling water pollutant using adsorption, oxidation and activation, wherein an integrated processing system has a stable persulfate combining with an adsorbent with low oxidation number (natural zeolite) and an iron-containing activator (e.g. industrial wastes, such as BF slags and BOF slags). When the adsorbent and activator co-exist, they can not only adsorb pollutants, but also activate the persulfate in a heterogeneous phase. Utilizing a principle of building a functional wall, the adsorbent can mix with the activator and persulfate to form a compound that can release the persulfate slowly in a long period of time, so that the functional wall formed by the released substance can not only delay the flow rate of the pollutants, but also efficiently remove the pollutants by the effect of heterogeneously catalyzing. Therefore, the system has the property of oxidizing, adsorbing and activating the persulfate to handle water or underground water polluted by organic substances.

Comparing with conventional techniques, the present invention has the following advantages:

(a) the integrated processing system has the persulfate, adsorbent with low oxidation number and iron-containing activator, wherein the persulfate has an oxidizing capability, the adsorbent (with low oxidation number) has an adsorbing capability, and the activator has transition metal, such as iron, to activate the persulfate. The system can not only increase the speed of eliminating pollutant, but also reduce the speed of pollutant movement to further reduce the threat of the pollution spreading to downstream;

(b) BF slag and BOF slag are industrial wastes, and the integrated processing system provides a channel for reusing the industrial wastes to easily process the industrial wastes;

(c) the activator can catalyze persulfate by itself to produce sulfate free radicals to enhance oxidation capability;

(d) the adsorbent has a function of self-cleaning, so the integrated processing system does not need a huge amount of adsorbent to reduce the costs of the pollution treatment site;

(e) the pollution treatment site can adjust the combination ratio of the persulfate, adsorbent and activator to receive the best efficiency of pollutants elimination; and

(f) the integrated processing system simultaneously possesses the functions of oxidation, activation and adsorption to efficiently eliminate pollutants and delay the pollutant flowing to downstream.

### BRIEF DESCRIPTION OF THE DRAWINGS

FIG. 1 illustrates a block diagram in the present invention.

FIG. 2 illustrates an embodiment of the integrated processing system in the present invention.

FIG. 3 illustrates another embodiment of the integrated processing system in the present invention.

FIG. 4 is a diagram showing different amount of BF slag vs. MTBE degradation.

FIG. 5 is a diagram showing different amount of BOF slag vs. MTBE degradation.

FIG. 6 is a diagram showing MTBE eliminating efficiency using zeolite

FIG. 7 illustrates a block diagram of a conventional art.

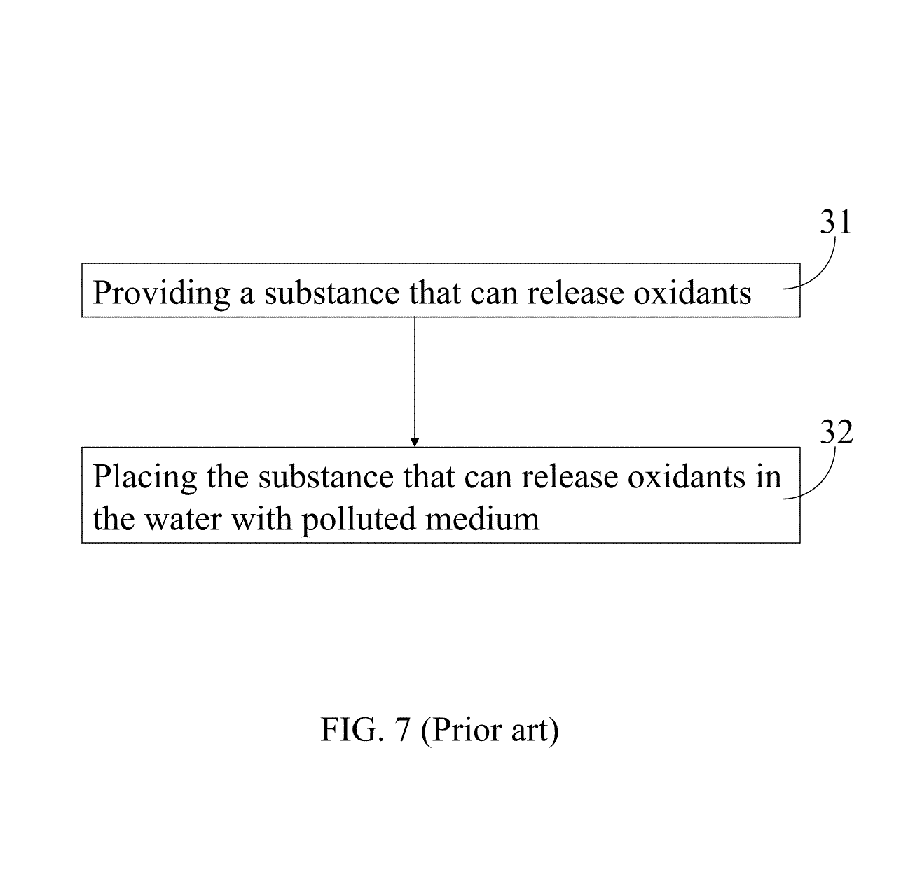

FIG. 8 is a schematic view of a conventional synthetic substance with an oxidant.

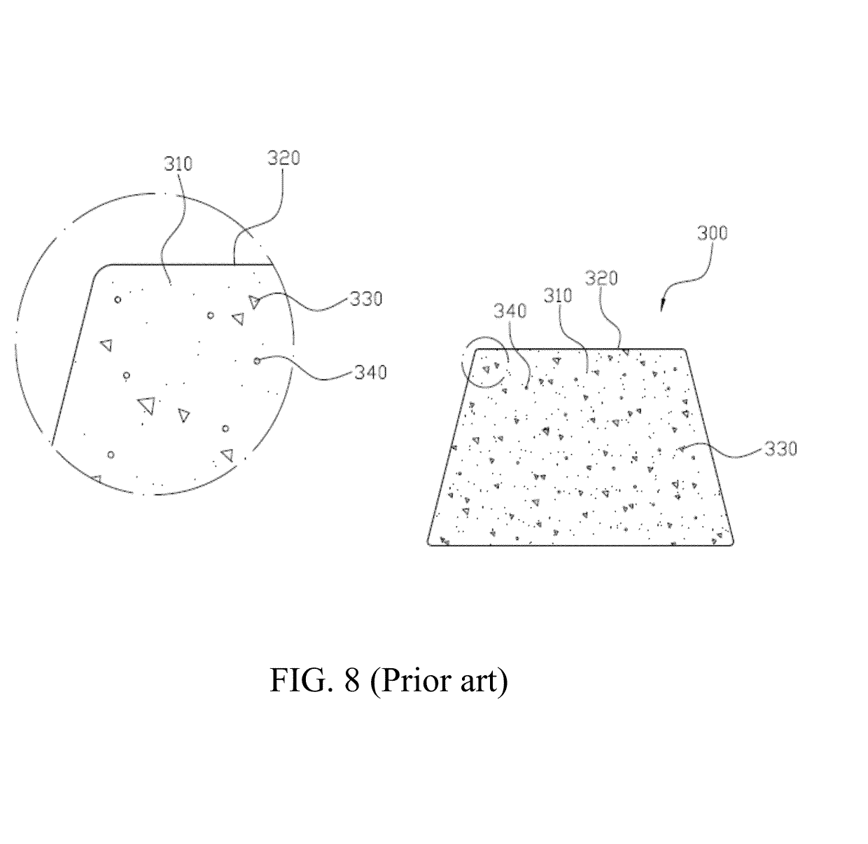

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

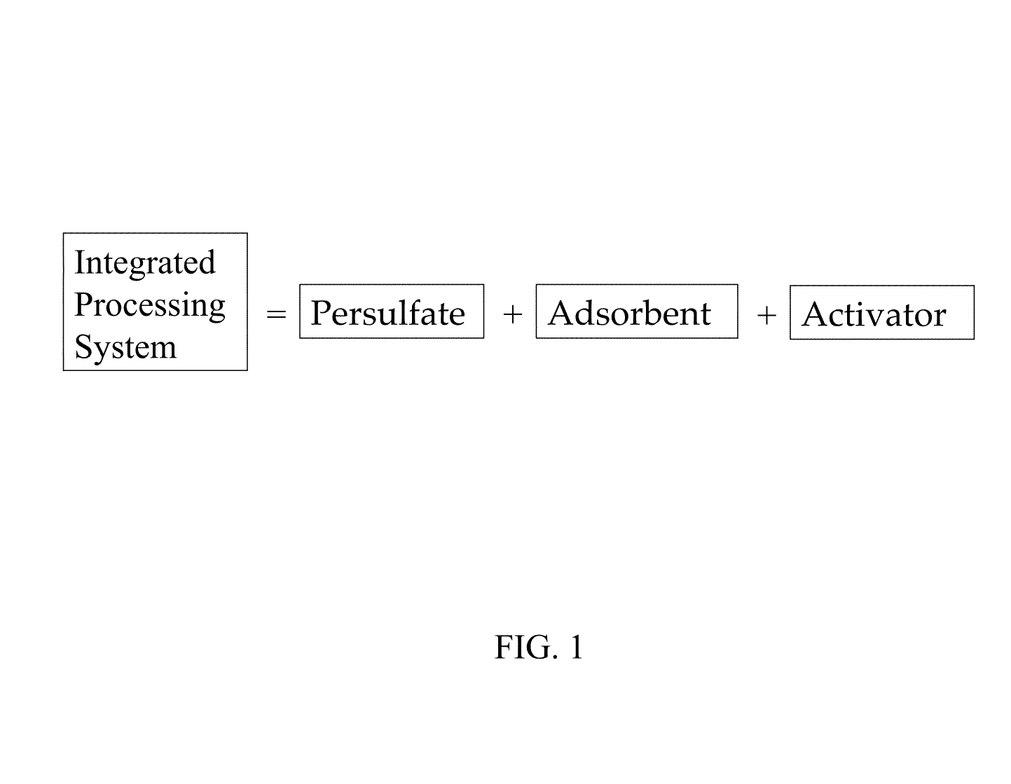

Referring to FIG. 1, the present invention provides a method of handling water pollutant using adsorption, oxidation and activation, wherein an integrated processing system (10) has a stable persulfate (11) combining with an adsorbent with low oxidation number (12) (e.g. natural zeolite) and an iron-containing activator (13) (e.g. from industrial wastes). When the adsorbent (12) and activator (13) co-exist, they can not only adsorb pollutants, but also activate the persulfate (11) in a heterogeneous phase. Utilizing a principle of building a functional wall, the adsorbent (12) can mix with the activator (13) and persulfate (11) to form a compound that can release persulfate (11) slowly in a long period of time, so that the functional wall formed by the released substance can not only delay the flow rate of the pollutants, but also efficiently remove the pollutants by the effect of heterogeneously catalyzing. Therefore, the system has the property of oxidizing, adsorbing and activating the persulfate (11) to handle water or underground water polluted by organic substances.

Persulfate (11) is a long-term oxidant in nature and tends not to react with the organic compounds in the soil, so that the required amount during reaction of persulfate (11) is lower than other oxidants. Thus, in addition to eliminate pollutants, using persulfate (11) can reduce the costs of the pollution treatment site.

Zeolite is an adsorbent (12) with low oxidation number, chosen from mordenite (Japan, reagent grade). As to the activator, blast furnace slag (BF slag) and basic oxygen furnace slag (BOF slag) are industrial wastes with different particle diameters, so before using them, a 10˜18 mesh (1˜2 mm) mesh sieve has to be used followed with 5% HCl to wash out the impurities, and deionized water has to be used to wash for several times. The slags are then dried for 24 hours at 105° C. and kept in a drying box (Cao et al., 2003). Since mordenite is a commercial chemical product, no pre-treatment is needed before using. According to the chemical component analysis in table 1, the percentage of iron in those two activators (13) is between 2.5 to 37.7% that indicates the potential for the activators (13) to oxidize persulfate (11).

TABLE 1
chemical composition of various activators

| Chemical | BF Slags | BOF Slags |
|---|---|---|
| elements | Percentage (%) | Percentage (%) |
| SiO₂ | 35.62 | 7.98 |
| CaO | 53.2 | 45.0 |
| Fe₂O₃ | 2.5 | 37.7 |
| BaO | 1.5 | — ¹ |
| MnO | 1.3 | 5.7 |
| TiO₂ | 1.0 | 0.6 |
| K₂O | 1.0 | — ¹ |
| SrO | 0.229 | 0.079 |
| ZrO₂ | 0.147 | 0.020 |
| Y₂O₃ | 0.036 | — ¹ |
| CuO | 0.025 | — ¹ |
| Rb₂O | 0.004 | — ¹ |
| PtO₂ | — ¹ | — ¹ |

¹ Not available

In order to understand the pollutant removing efficiency of the integrated processing system (10) in the present invention, methyl tert-butyl ether (MTBE) is used as a target pollutant to compare the difference from using the integrated processing system (10) in the present invention and oxidation, activation and adsorption. According to the experimental results, the adsorbent (12) is used for adsorbing pollutant, activator (13) is helpful in the process of catalyzing persulfate (11) to degrade MTBE, and the degrading efficiency is enhanced when the amount of the activator (13) increases because the activator (13) contains metal components such as iron.

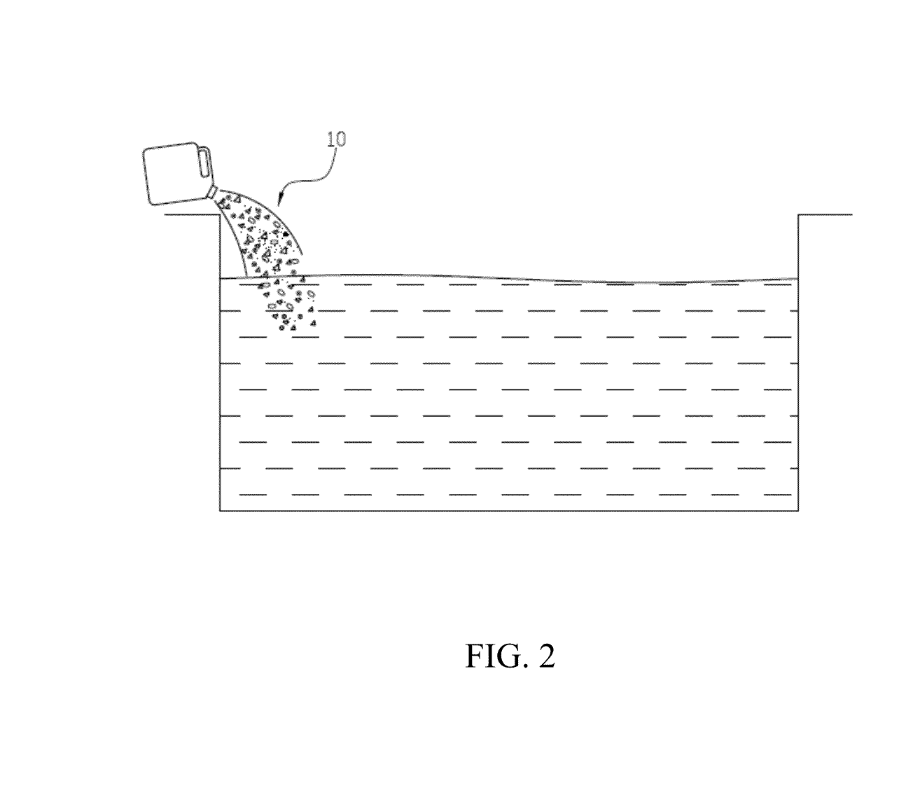

In one embodiment, when using the integrated processing system (10) (having functions of adsorption, oxidation and activation), the persulfate (11), adsorbent (12) and iron-containing activator (13) are directly added to the polluted water and underground water to destroy the pollutants by using oxidation, activation and adsorption mechanisms (see FIG. 2 as well).

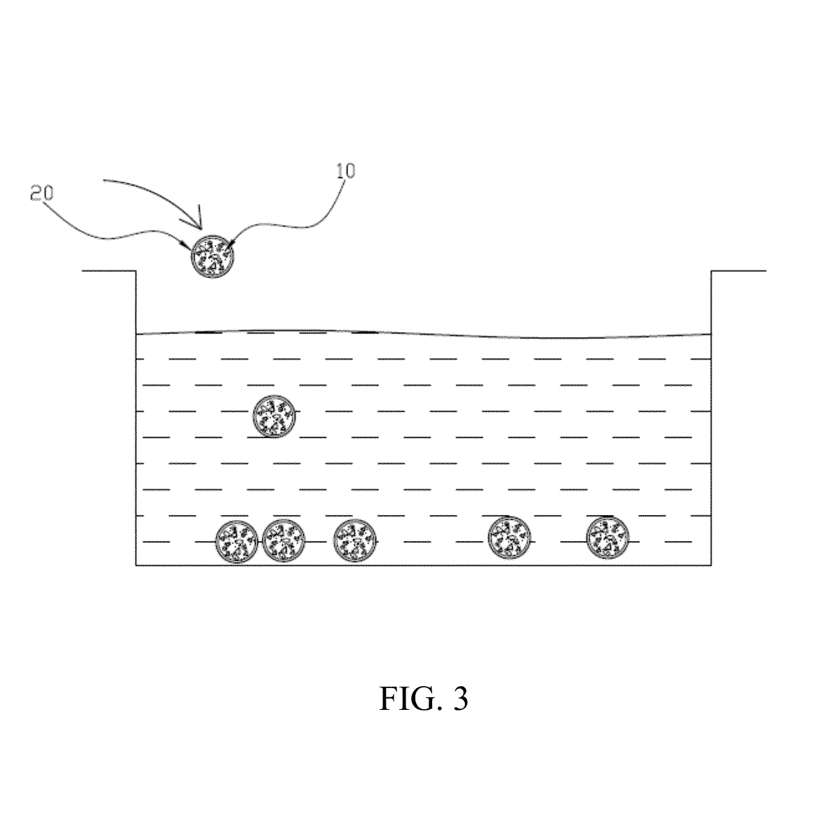

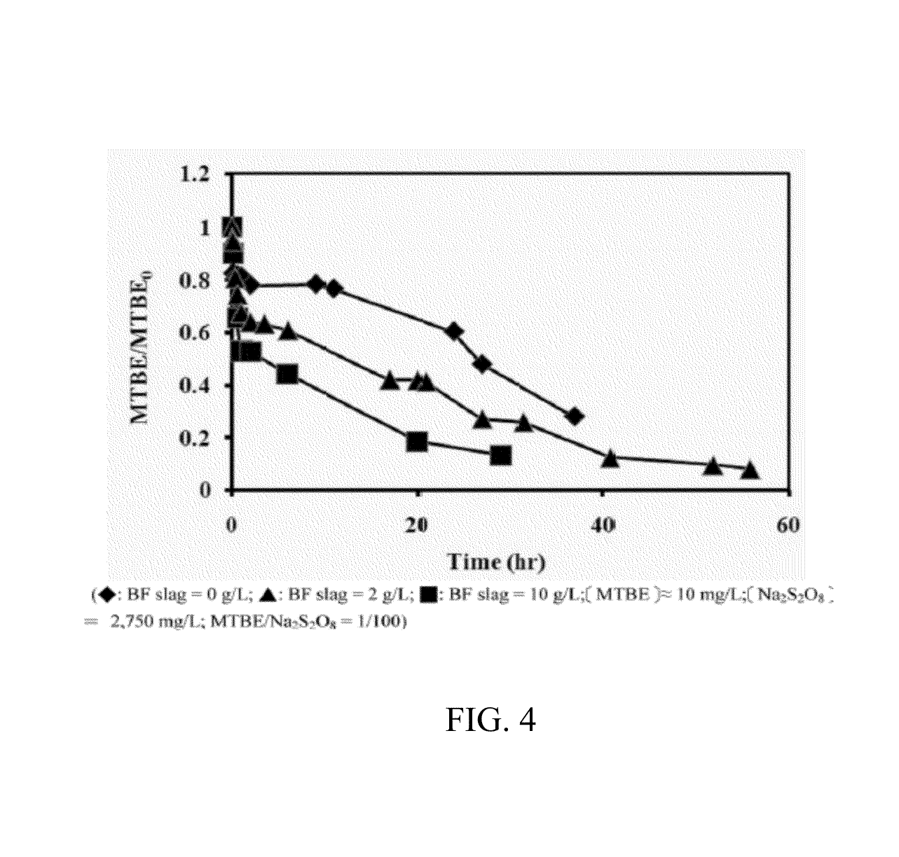

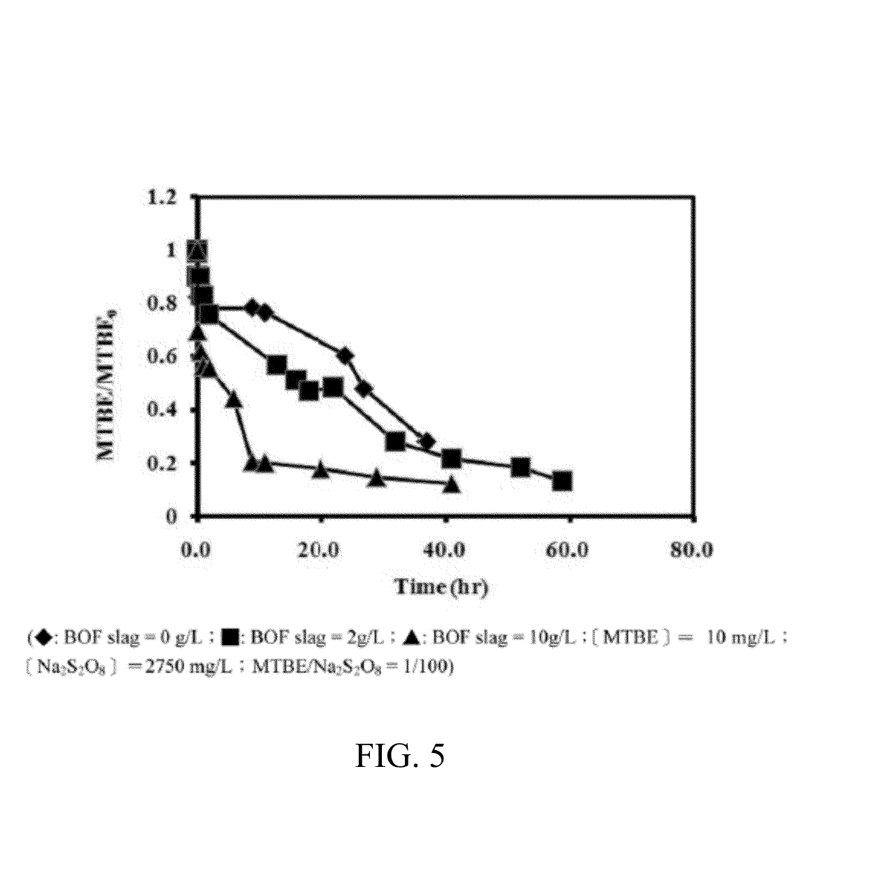

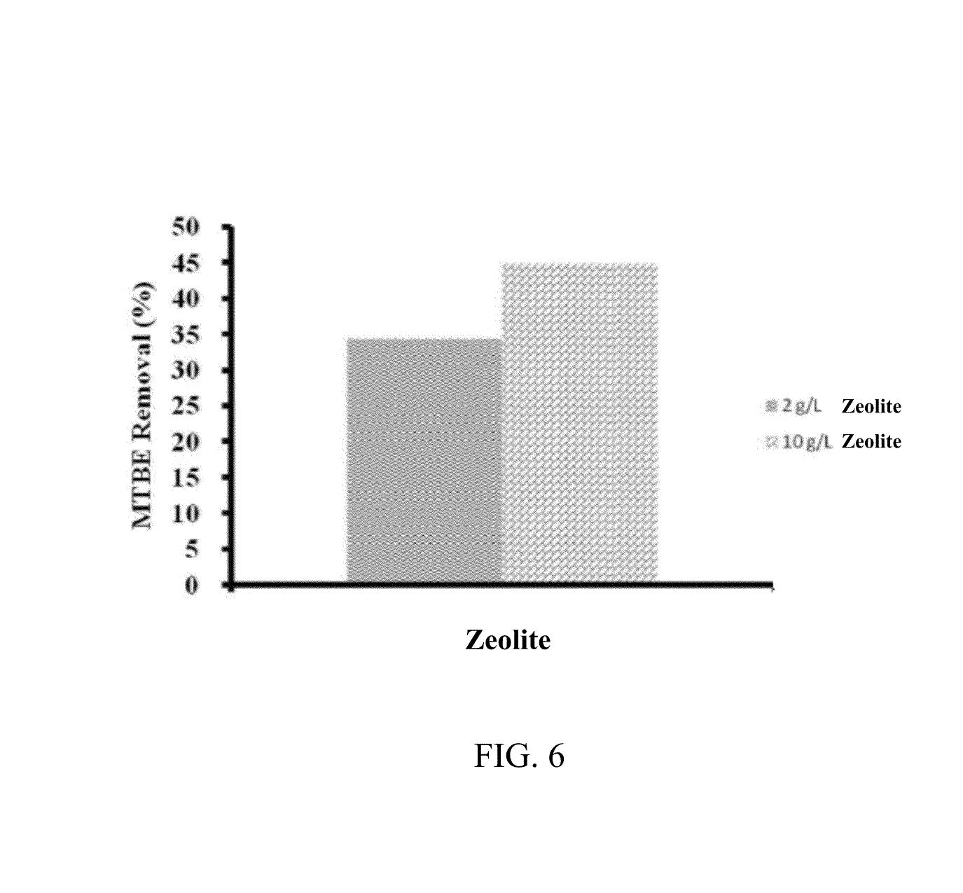

In another embodiment, the persulfate (11), adsorbent (12) and iron-containing activator (13) can be enclosed in cement (20) and then disposed in the polluted water and underground water (see FIG. 3 as well). When the water seeps into the cement (20), the persulfate (11) can be released to prolong the existing time of the persulfate (11), and further destroy the pollutants along with oxidation, activation and adsorption mechanisms. In this semi-permeable synthetic substance, the persulfate (11) is an oxidant, and sand can increase porosity of the substance to release the persulfate (11). The adsorbent (12) and activator (13) can not only serve the functions of adsorption and heterogeneous catalyzing, but also replace sand to increase porosity. The cement (20) is a coagulant to hold every composition together, and the synthetic substance can be completely dried after being placed in a fairly cool environment for 2-3 days. The surface of the synthetic substance has a plurality of micro-porous structures to facilitate the release of the persulfate (11) for a long period of time. According to the experimental results of accumulated releasing amount of the persulfate (11) (experimental results shown in FIGS. 4 to 6), its accumulated releasing time can maintain about 30 days or more, wherein the releasing rate is the highest within the first five days and then reaches a steady state, which indicates that the oxidant releasing substance has an effect of releasing oxidant for a long period of time.

According to the structure shown in the embodiments, the present invention has the following advantages: (a) the integrated processing system (10) has the persulfate (11), adsorbent (12) with low oxidation number and iron-containing activator (13), wherein the persulfate (11) has an oxidizing capability, the adsorbent (12) (with low oxidation number) has an adsorbing capability, and the activator (13) has transition metal, such as iron, to activate the persulfate (11). The system (10) can not only increase the speed of eliminating pollutant, but also reduce the speed of pollutant movement to further reduce the threat of the pollution spreading to downstream; and (b) BF slag and BOF slag are industrial wastes, and the integrated processing system (10) provides a channel for reusing the industrial wastes to easily process the industrial wastes; (c) the activator (13) can catalyze the persulfate (11) by itself to produce sulfate free radicals to enhance oxidation capability; (d) the adsorbent has a function of self-cleaning, so the integrated processing system (10) does not need a huge amount of adsorbent (12) to reduce the costs of the pollution treatment site; (e) the pollution treatment site can adjust the combination ratio of the persulfate (11), adsorbent (12) and activator (13) to receive the best efficiency of pollution elimination; and (f) the integrated processing system (10) simultaneously possesses the functions of oxidation, activation and adsorption to efficiently eliminate pollutants and delay the pollutant flowing to downstream.

Having described the invention by the description and illustrations above, it should be understood that these are exemplary of the invention and are not to be considered as limiting. Accordingly, the invention is not to be considered as limited by the foregoing description, but includes any equivalent

What is claimed is:

1. An integrated processing system to adsorb, oxidize and activate water pollutants comprises a persulfate, an adsorbent and an iron-containing activator, wherein the persulfate is stably combine with the adsorbent with low oxidation number and the iron-containing activator, so the integrated processing system serves functions of oxidation, adsorption and activation to accelerate removal of water pollutants, delay movement of the water pollutants, and reduce threat of the pollutants spreading to downstream.

2. The integrated processing system of claim 1, wherein the adsorbent is a neolite.

3. The integrated processing system of claim 1, wherein the activator includes industrial wastes such as blast furnace slag (BF slag) and basic oxygen furnace slag (BOF slag).

4. The integrated processing system of claim 1, wherein the persulfate, adsorbent with low oxidation number and activator are directly added to polluted water and underground water to destroy pollutants therein by oxidation, adsorption and activation mechanisms.

5. The integrated processing system of claim 1, wherein the persulfate, adsorbent with low oxidation number and activator are enclosed in cement and placed into polluted water and underground water, and when the water seeps into the cement, the persulfate is released to prolong existing time of the persulfate and destroy pollutants by oxidation, adsorption and activation mechanisms.
